(19) United States
(12) Patent Application Publication
(10) Pub. No.: US 2024/0281590 A1
(43) Pub. Date: Aug. 22, 2024

(54) CORRECTING HL7 OBSERVATION VALUE TYPES USING REGULAR EXPRESSIONS

(71) Applicant: Optum, Inc., Minnetonka, MN (US)

(72) Inventor: Nicholas Owen Radov, Los Gatos, CA (US)

(21) Appl. No.: 18/170,278

(22) Filed: Feb. 16, 2023

(51) Int. Cl. G06F 40/126; G06F 40/226

(52) U.S. Cl. CPC G06F 40/126; G06F 40/226

(57) ABSTRACT

The techniques of this disclosure may automatically detect and correct incorrect observation value types when it is possible to do so without loss of clinical data fidelity. The techniques may be applied to a medical information transfer system, such an HL7 clinical data pipeline. If the corrected data type is a compound type comprising multiple discrete components, the observation value may be parsed out to the compound data type.

### TECHNICAL FIELD

This disclosure relates to medical coding and classification.

### BACKGROUND

Medical information transfer systems, such as industry standards defined by HL7 (Health Level Seven International), are used to electronically transfer health-related information between different healthcare providers and organizations. These systems facilitate the sharing of patient information, such as medical records, test results, and medication lists, to improve patient care and reduce the risk of errors.

Medical information transfer systems use medical coding terminologies to classify and organize medical diagnoses and observations for billing and record-keeping purposes. Medical coding terminologies include (but are not limited to) the Logical Observation Identifiers Names and Codes (LOINC) system, which is used to standardize the names and codes for laboratory and other clinical observations, International Classification of Diseases (ICD), Current Procedural Terminology (CPT), and Healthcare Common Procedure Coding System (HCPCS) codes, and SNOMED CT (Systematized Nomenclature of Medicine Clinical Terms).

### SUMMARY

The present disclosure describes devices, systems, and methods to improve the transfer of medical coding information between clinical systems. Submitters such as reference laboratories sometimes put the wrong value types on observations due to software defects, configuration errors, or misunderstandings about how to properly implement medical coding information. For example, a systolic blood pressure observation with a value of “120” might be submitted as a value type of string rather than as a number. This may prevent the recipient from closing care quality gaps, performing analytics, or comparing similar observations submitted by different organizations.

The techniques of this disclosure may automatically detect and correct incorrect observation value types when it is possible to do so without loss of clinical data fidelity. The techniques may be applied to a medical information transfer system, such an HL7 clinical data pipeline, such as within an interface engine. If the matched data type is a compound type, such as structured numeric, comprising multiple discrete components, the observation value may be parsed out to the compound data type.

In one example, this disclosure describes a method comprising: receiving, by a computing system, a medical coding string including a medical observation code, an initial data type, and an observation value; determining, by the computing system, that the initial data type is not valid for the medical observation code; determining, by the computing system, a set of acceptable data types for the medical observation code; checking, by the computing system, a validity of the observation value with respect to each member of the set of acceptable data types for the medical observation code; determining, by the computing system, that the observation value is valid for only a single acceptable data type of the set of acceptable data types for the medical observation code; and based on the determination that the observation value is valid for only the single acceptable data type, replacing, by the computing system, the initial data type in the medical coding string with the single acceptable data type to create an updated medical coding string.

In another example, this disclosure describes a computing system comprising a communication unit configured to connect with a network; and one or more processors implemented in circuitry and in communication with the communication unit, the one or more processors configured to: receive a medical coding string including a medical observation code, an initial data type, and an observation value; determine that the initial data type is not valid for the medical observation code; determine a set of acceptable data types for the medical observation code; check the validity of the observation value with respect to each member of the set of acceptable data types for the medical observation code; determine that the observation value is valid for only a single acceptable data type of the set of acceptable data types for the medical observation code; and based on the determining that the observation value is valid for only the single acceptable data type, replace the initial data type in the medical coding string with the single acceptable data type to create an updated medical coding string.

In another example, this disclosure describes a non-transitory computer-readable medium having instructions stored thereon that, when executed, cause one or more processors to: receive a medical coding string including a medical observation code, an initial data type, and an observation value; determine that the initial data type is not valid for the medical observation code; determine a set of acceptable data types for the medical observation code; check the validity of the observation value with respect to each member of the set of acceptable data types for the medical procedure code; determine that the observation value is valid for only a single acceptable data type of the set of acceptable data types for the medical observation code; and based on the determining that the observation value is valid for only the single acceptable data type, replace the initial data type in the medical coding string with the single acceptable data type to create an updated medical coding string.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example environment including a computing system that implements medical information transfer and medical information string correction in accordance with one or more aspects of this disclosure.

FIG. 2 is a block diagram illustrating an example computing system that implements a medical information transfer and medical information string correction in accordance with one or more aspects of this disclosure.

FIG. 3 is a diagram that illustrates clinical data acquisition flow through a HL7 Interface in accordance with one or more aspects of this disclosure.

FIG. 4 is a flow chart that illustrates an example process for medical information string correction in accordance with one or more aspects of this disclosure.

FIG. 5 is a diagram that illustrates HL7 Observation Data Elements in accordance with one or more aspects of this disclosure.

FIGS. 6A-C are diagrams that illustrate LOINC Scale Types relations to data types in accordance with one or more aspects of this disclosure.

FIGS. 7A-C are diagrams that illustrate example regular expressions for data types in accordance with one or more aspects of this disclosure.

FIG. 8 is a flowchart that illustrates a method in accordance with one or more aspects of this disclosure.

### DETAILED DESCRIPTION

Popular medical information transfer standards are published by HL7 (Health Level Seven International). HL7 is an ANSI accredited standards development organization which publishes a set of international standards for transferring electronic medical data between software systems used by various healthcare organizations. HL7 provides a framework for the use of coding protocols in the exchange of healthcare information between different systems and organizations. An HL7 interface is a way for different software systems to communicate with each other using the HL7 standards. This allows different systems to exchange information about patients, appointments, test results, and other data, enabling healthcare organizations to have a more comprehensive view of a patient's health and treatment history.

An HL7 interface engine acts as a translator, converting data from one system's format into a format that may be understood by another system. The interface engine may be configured to handle different types of HL7 messages and to map data between different systems. The interface engine may also handle tasks such as error checking, message acknowledgement, and routing messages to the appropriate destination. An HL7 interface engine is typically used in healthcare organizations to enable the exchange of information between clinical systems, such as electronic medical record systems, laboratory information systems, and radiology information systems.

An enterprise may acquire clinical data in a variety of industry standard HL7 formats including V2 Messaging, Clinical Document Architecture (CDA), and Fast Healthcare Interoperability Resources (FHIR). V2 Messaging, Clinical Document Architecture (CDA), and Fast Healthcare Interoperability Resources (FHIR) are all standards used in the exchange of healthcare information.

V2 Messaging is a set of standards developed by the Health Level Seven International (HL7) organization for the exchange of healthcare information in a structured format. V2 messaging is mainly used for the exchange of administrative and clinical information, such as patient demographics, lab results, appointment schedules, and billing information.

Clinical Document Architecture (CDA) is another HL7 standard for the exchange of clinical information, such as patient medical records and laboratory results. CDA documents are based on Extensible Markup Language (XML) and provide a consistent format for the representation of clinical information.

Fast Healthcare Interoperability Resources (FHIR) is a newer standard developed by HL7 that is designed to be more flexible and easier to implement than previous standards. FHIR uses modern web technologies like RESTful APIs and JSON to exchange healthcare information. FHIR is designed to work with existing systems and technologies. FHIR is mainly used for exchanging clinical information such as patient's demographics, allergies, medications, etc.

LOINC (Logical Observation Identifiers Names and Codes) is a standardized terminology system for identifying laboratory and clinical observations. It provides a standardized way to represent the names and codes of laboratory and clinical observations, such as blood tests, vital signs, and diagnostic procedures. The LOINC codes are used to help ensure that the results of these observations may be accurately and consistently interpreted, regardless of the system or location in which the observations were performed. LOINC codes may be used in conjunction with any of the HL7 standards listed above to exchange laboratory and clinical observations between different healthcare systems. LOINC codes may also be used in other contexts, such as electronic health record systems, to identify and classify observations consistently.

In the LOINC terminology system, each laboratory or clinical observation has a unique code, a name, and a set of associated properties. One of these properties is the scale type, which describes the type of measurement being made. There are several different scale types used in LOINC, including:
Numeric: A numerical measurement, such as a blood pressure reading or a quantitative laboratory test result.
Ordinal: A measurement that has a fixed set of categories, such as “positive” or “negative” for a diagnostic test, or “normal” or “abnormal” for a laboratory value.
Nominal: A measurement that has a fixed set of categories, but the categories are not ordered. For example, a blood type test might have the categories “A,” “B,” “AB,” and “O.”
Narrative: A free-text measurement, such as a clinician's notes or a patient's comments.

Often, the wrong data type is provided on observations due to software defects, configuration errors, or misunderstandings about how to properly implement the HL7 standards. For example, a systolic blood pressure observation with a value of “120” might be submitted as a data type of string rather than as a number. This may prevent the easy use of this observation by a receiving organization. Some observations have incorrect data type. The error of using a “string” data type for quantitative observations is the most common error. Such erroneous strings are still human readable but might not be interpreted correctly by computers.

The techniques of this disclosure may automatically detect and correct incorrect observation value types when it is possible to do so. As described below, a computing system may check a medical observation code string to see if the initial data type is invalid for a medical observation code. For example, if the initial data type is “string”, this initial data type may be invalid for a systolic blood pressure observation as indicated by the medical observation code. Thus, an observation value of “120” may not be useable since it is interpreted as a string rather than a numeric value.

The computing system may obtain a set of acceptable data types for the medical observation code then see if a single acceptable data type is valid (such as with a regular expression) for the observation value (“120” in the example). If a single acceptable data type is valid, the single acceptable data type may be used to replace the initial data type. For example, if the single acceptable data type for the medical observation code for systolic blood pressure is numeric and an observed value of “120” is valid for the numeric data type, the initial data type of “string” may be replaced by the single acceptable data type of “numeric”. In this way, the computing system may automatically update the medical coding string and thus the medical coding string does not have to be manually updated.

If the matched data type is a compound type consisting of multiple discrete components, the computing system may parse out the components of the compound type and replace the observation value. For example, if the data is in HL7 V2 Messaging format and the matched data type is SN (Structured Numeric) and the observation value is “3.0-4.0” then the computing system may parse the observation value into the four SN components: SN.1 (Comparator)=“ ” (not populated), SN.2 (Num1)=“3.0”, SN.3 (Separator/Suffix)=“-”, SN.4 (Num2)=“4.0”.

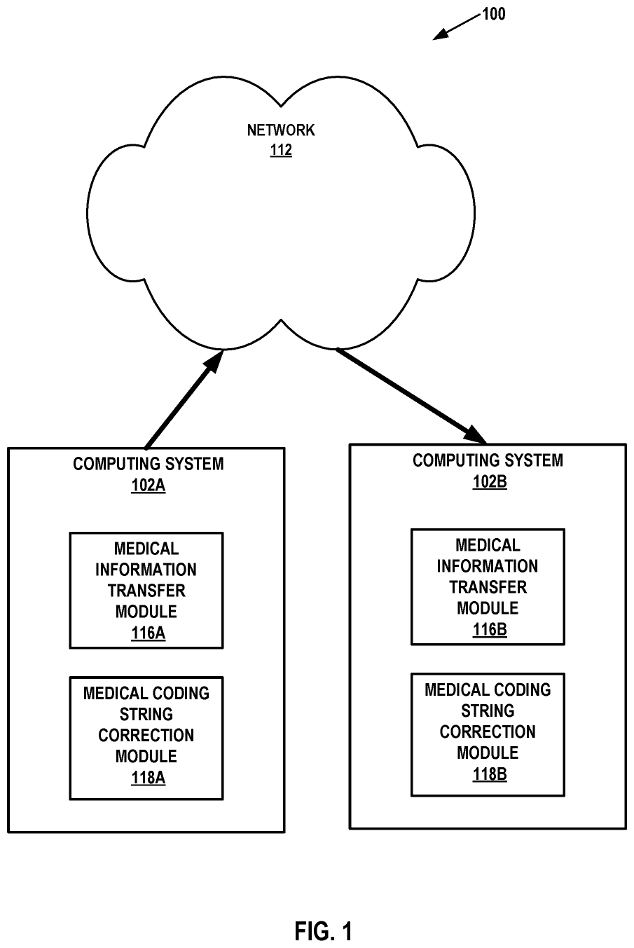

FIG. 1 is a block diagram illustrating an example environment including a system 100 that implements medical information transfer and medical information string correction according to techniques of this disclosure. In the example of FIG. 1, system 100 includes computing system 102A that implements medical information transfer module 116A that prepares and sends medical information to computing system 102B. System 100 may also include computing system 102B that may implement medical information transfer module 116B that receives and uses medical information from computing system 102A. Computing system 102B may also include medical coding string correction module 118B that allows for the correction of received medical information as described below. The examples below focus on correcting received medical information but similar functionality may be included in computing system 102A in medical coding string correction module 118A before sending the medical information.

Computing systems 102A and 102B may be any type of computing device or system. For example, computing systems 102A and 102B may be personal computers, enterprise systems, mainframe systems, supercomputing systems, cloud computing systems, mobile computing systems, embedded computing systems, web servers, desktops, tablets, smartphones and workstations.

Medical information transfer modules 116A and 116B may be, for example, HL7 software modules such as HL7 interface engines and modules that interface with HL7 interface engines. Medical coding string correction module 118B or 118A may interface with medical information transfer modules 116A and 116B so as to correct medical information as discussed below. Medical coding string correction module 118B or 118A may in one example interface with an HL7 interface engine before it transfers the medical information to another location.

Network 112 may comprise a public network, such as the Internet, or a private network. Although illustrated as a single entity, network 112 may comprise a combination of public and/or private networks. In some examples, network 112 may comprise one or more of a wide area network (WAN) (e.g., the Internet), a local area network (LAN), a virtual private network (VPN), or another wired or wireless communication network.

Computing systems 102A and 102B may include any device configured to receive, process, and/or send electronic, digital, and/or computer information. For example, computing systems 102A and 102B may include any or all types of computing devices such as desktop or laptop computers, mobile devices, smartphones, smartwatches, smart glasses, or any smart devices, tablet computers, wearable devices, servers, intermediate network devices, workstations, vehicle computing systems or on-board computers, or the like.

In accordance with one or more techniques of this disclosure, computing system 102B may detect and correct incorrect medical coding strings in certain situations. Computing system 102B may receive a medical coding string including a medical observation code, an initial data type, and an observation value.

The medical coding string may be in any format such as a HL7 V2 Messaging format, Clinical Document Architecture (CDA) format, Fast Healthcare Interoperability Resources (FHIR) format or another format. The medical observation code may be a Logical Observation Identifiers Names and Codes (LOINC) code. A LOINC code is a unique alphanumeric identifier that is assigned to each observation type in the LOINC system. The code consists of several parts, including the LOINC class (e.g., CHEM for chemistry observations), the component (e.g., glucose), and the property (e.g., serum). LOINC codes are designed to be unambiguous, so that the same test performed at different laboratories will have the same LOINC code. In the context of HL7, LOINC codes identify observations in messages and documents. By using standardized LOINC codes, HL7 ensures that laboratory results may be accurately and consistently exchanged between different healthcare providers, regardless of the different coding systems used by each provider.

The observation value may be a specific data point or measurement recorded for a patient. The observation value may be a laboratory test result, a vital sign, or a clinical observation. The medical observation code provides the context for the observation value.

The data type may indicate the format of the observation value, such as “numeric” or “string”. The initial data type is the data type received in the medical coding string but, as discussed below, this type may be wrong and corrected by computing system 102B.

Computing system 102B may determine that the initial data type is not valid for the medical observation code. For example, the medical observation codes may have associated sets of acceptable data types. Each LOINC code has a defined acceptable scale type. Computing system 102B may obtain the sets of acceptable data types for a medical observation code from a local or external database.

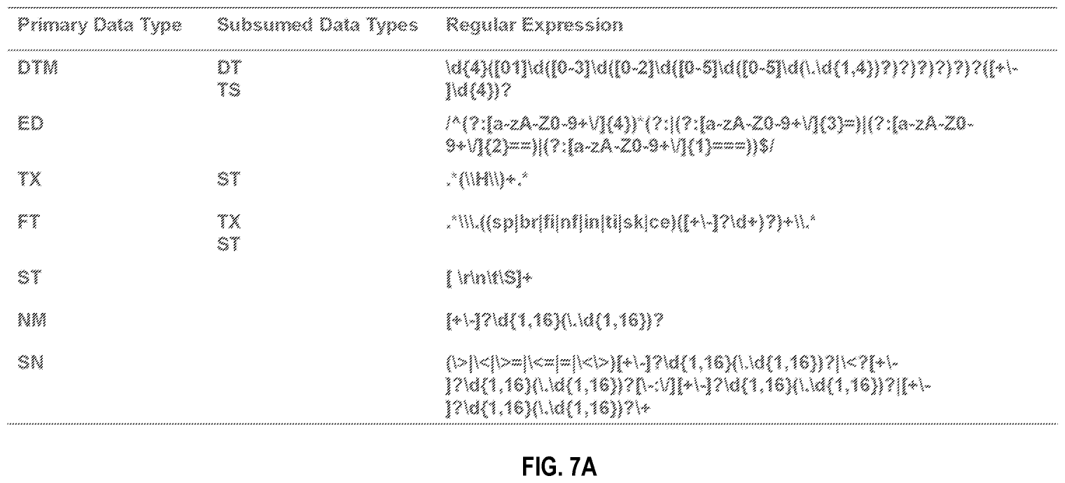

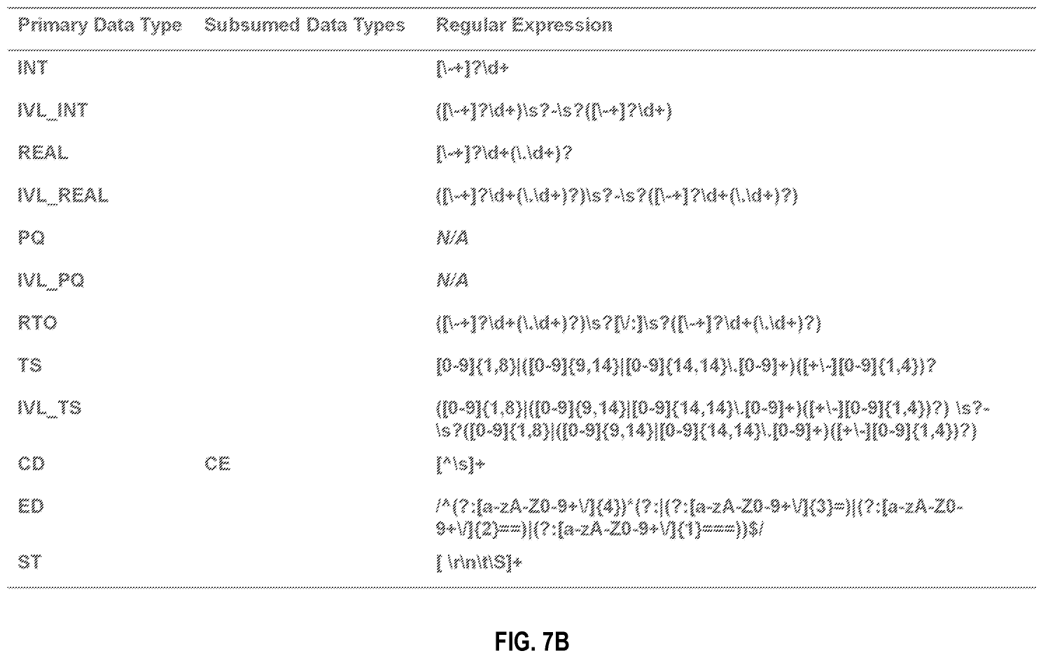

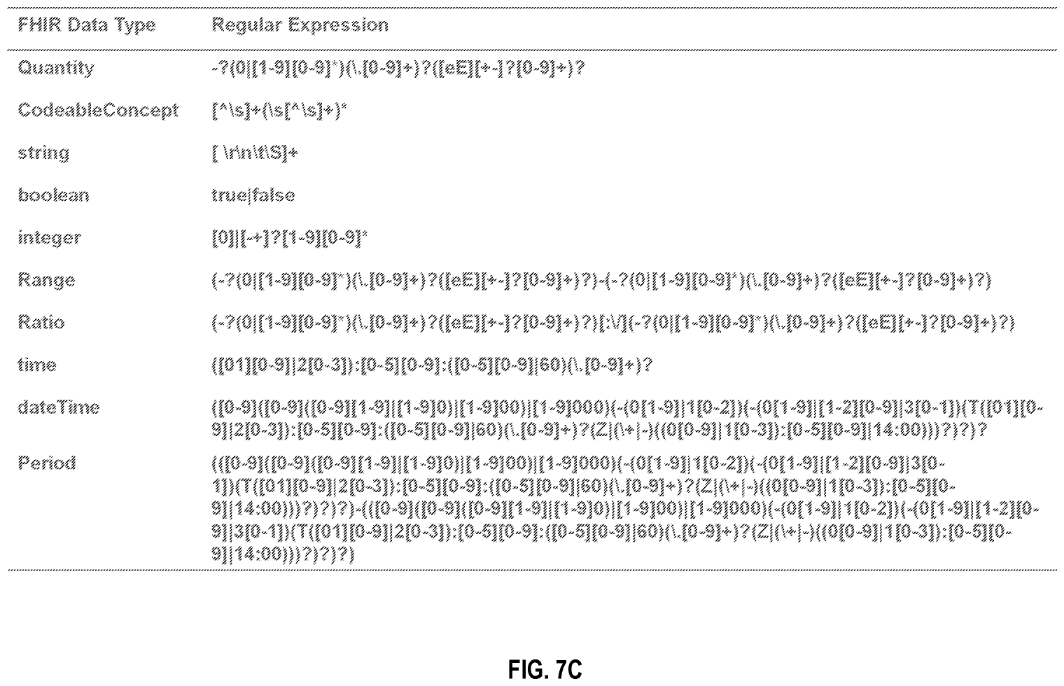

Computing system 102B may check a validity of the observation value with respect to each member of the set of acceptable data types for the medical observation code. For example, computing system 102B may obtain a regular expression (regex) for each member of the set of acceptable data types. For each member of the set of acceptable data types, check the observation value to determine if the observation value satisfies the regular expression for that member. FIGS. 7A-7C discussed below show examples of regular expressions for different data types.

A regular expression, or regex, is a sequence of characters that defines a search pattern. Regular expressions are often used in text processing to search for and manipulate specific patterns of characters in a body of text. Regular expressions are a powerful tool for matching and manipulating strings, and may perform tasks including validating that a string conforms to a specific pattern. Regular expressions are supported by many programming languages and text processing tools, and have their own syntax and rules for constructing patterns.

Computing system 102B may check a validity of the observation value using an alternative techniques. Alternatives to the use of regular expression for validation may include built-in string manipulation functions which are provided by many programming languages. Example string manipulation functions may include as substring, indexOf, and replace. Other example alternatives to regular expressions may include parsing libraries that are specialized libraries available that may be used to parse specific types of text or data. Other example alternatives to regular expressions may include finite state machines which are mathematical models for representing and processing sequential data which may be used to recognize patterns in strings and other types of input. Machine learning models may be trained to perform pattern matching tasks may be another alternative to regular expressions.

If computing system 102B determines that the observation value is valid for only a single acceptable data type of the set of acceptable data types for the medical observation code, computing system 102B may correct the data type. Based on the determining that the observation value is valid for only the single acceptable data type, computing system 102B may replace the initial data type in the medical coding string with the single acceptable data type to create an updated medical coding string. For example, if the single acceptable data type for the medical observation code for systolic blood pressure is numeric and an observed value of “120” is valid for the numeric data type, computing system 102B may replace the initial data type of “string” with the single acceptable data type of “numeric”.

If the set of acceptable data types only has a single data type and the observation value is valid for that single data type, computing system 102B may replace the initial data type with the single data type. If the set of acceptable data types has multiple data types and the observation value is valid for only a single acceptable data type (i.e., the observation value satisfies the single acceptable data type but does not satisfy any other data type of the set of acceptable data types), computing system 102B may replace the initial data type with the single acceptable data type. In one example, if there are no data types in the set of acceptable data types or there are multiple data types in the set of acceptable data types is satisfied by the observation value, computing system 102B does not modify the initial data type.

A compound data type is a data type that includes multiple discrete components. The multiple discrete components may be subparts of the compound data type having different data types. If the single acceptable data type is a compound data type, computing system 102B may parse the observation value into multiple discrete components of the compound data type. The compound data type may be the structured numeric data type which may unambiguously express numeric clinical results along with qualifications.

The structured numeric compound data type may have up to four subparts:
SN.1—Comparator of data type ST;
SN.2—Num1 of data type NM;
SN.3—Separator/Suffix of data type ST; and
SN.4—Num2 of data type NM

The structured numeric compound data type enables receiving systems to store the components separately, and facilitates the use of numeric database queries. If <num1> and <num2> are both non-null, then the separator/suffix must be non-null. If the separator is “-”, the data range is inclusive; e.g., <num1>-<num2> defines a range of numbers x, such that: <num1><=x<=<num2>.

Computing system 102B may parse observation values into the structured numeric values based on the rules for the structured numeric data type. For example, if the data is in HL7 V2 Messaging format and the matched data type is SN (Structured Numeric) and the observation value is “3.0-4.0” then, computing system 102B may parse the value into the four SN components: SN. 1 (Comparator)=“ ” (not populated), SN.2 (Num1)=“3.0”, SN.3 (Separator/Suffix)=“-”, SN.4 (Num2)=“4.0”. Computing system 102B may parse “3.0-4.0” by determining the first number “3.0” occurs before a possible comparator so SN.1 is set to null; the first number is determined as “3.0” which is set to SN.2; next comes “-” (indicating a range) which is a valid Separator/Suffix so SN.3 is set to “-”; finally, “4.0” is a valid number so SN.4 is set to “4.0”.

In another example, computing system 102B may parse an observation value “<1:64” as a structured numeric data type, as SN.1=“<”, SN.2=“1”, SN.3=“ ”, SN.4=“64”. Computing system 102B may parse “<1:64” by determining that “<” is a valid comparator so SN.1 is set to “<”; the first number is determined as “1” which is a number so SN.2 is set to “1”; next comes “:” (indicating a ratio) which is a valid Separator/Suffix so SN.3 is set to “:”; finally, “64” is a valid number so SN.4 is set to “64”.

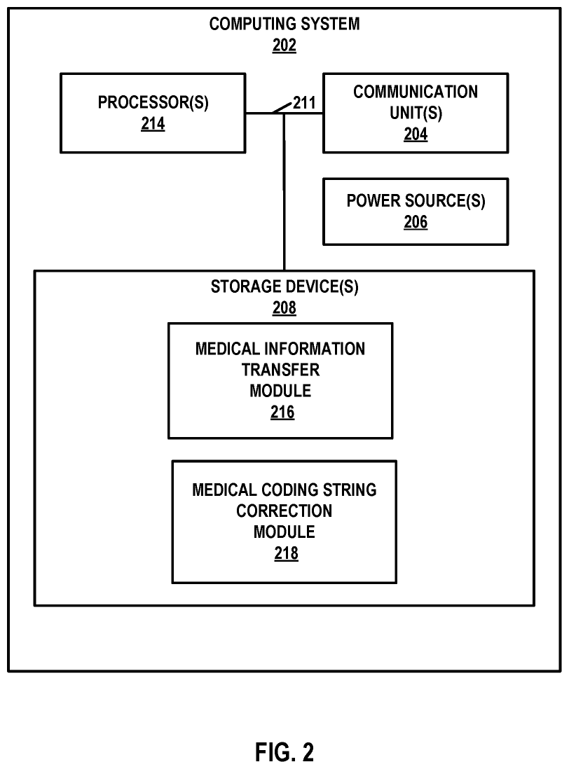

FIG. 2 is a block diagram illustrating an example computing system that implements a medical information transfer and medical information string correction, in accordance with one or more aspects of this disclosure. FIG. 2 illustrates only one example of computing system 202, without limitation on many other example configurations of computing system 202, and may comprise a separate system of one or more computing devices. Computing system 202 may correspond to one of computing systems 102B or 102A of FIG. 1.

As shown in the example of FIG. 2, computing system 202 includes one or more processors 214, one or more communication units 204, one or more power sources 206, one or more storage devices 208, and one or more communication channels 211. Computing system 202 may include other components. For example, computing system 202 may include input devices, output devices, display screens, and so on. Communication channels 211 may interconnect each of processors 214, communication units 204, and storage devices 208 for inter-component communications (physically, communicatively, and/or operatively). In some examples, communication channels 211 may include a system bus, a network connection, an inter-process communication data structure, or any other method for communicating data. Power sources 206 may provide electrical energy to processors 214, communication units 204, storage devices 208 and communication channels 211. Storage devices 208 may store information for use during operation of computing system 202

Processors 214 comprise circuitry configured to perform processing functions. For instance, one or more of processors 214 may be a microprocessor, an application-specific integrated circuit (ASIC), a field-programmable gate array (FPGA), or another type of processing circuitry. In some examples, processors 214 of computing system 202 may read and execute instructions stored by storage devices 208. Processors 214 may include fixed-function processors and/or programmable processors. Processors 214 may be in a single device or distributed among multiple devices.

Communication units 204 may enable computing system 202 to send data to and receive data from one or more other computing devices (e.g., via a communications network, such as a local area network or the Internet). In some examples, communication units 204 may include wireless transmitters and receivers that enable computing system 202 to communicate wirelessly with other computing devices. Examples of communication units 204 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc. Computing system 202 may use communication units 204 to communicate with one or more other computing devices or systems. Communication units 204 may be in a single device or distributed among multiple devices.

Processors 214 may read instructions from storage devices 208 and may execute instructions stored by storage devices 208. Execution of the instructions by processors 214 may configure or cause computing system 202 to provide at least some of the functionality ascribed in this disclosure to computing system 202. Storage devices 208 may be in a single device or distributed among multiple devices.

As shown in the example of FIG. 2, storage devices 208 may include computer-readable instructions associated with medical coding string correction module 218 and medical information transfer module 216, corresponding to medical coding string correction module 118B and medical information transfer module 116B of FIG. 1. Medical coding string correction module 218 and medical information transfer module 216 shown in the example of FIG. 2 is presented for purposes of explanation and may not necessarily correspond to actual software units or modules within storage devices 208.

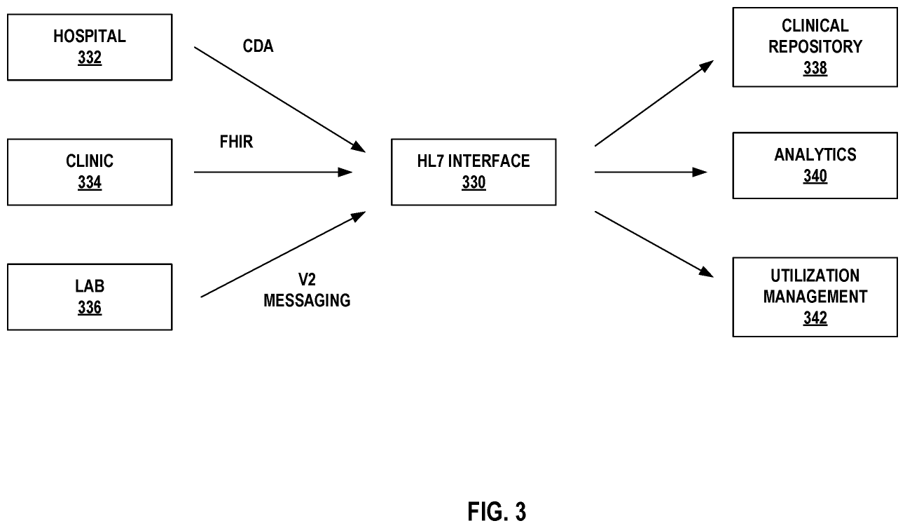

FIG. 3 is a diagram that illustrates clinical data acquisition flow through HL7 Interface 330 in accordance with one or more aspects of this disclosure. HL7 Interface 330 may correspond to medical information transfer modules 116A or 116B of FIG. 1. In this example, multiple locations including a hospital 332, a clinic 334, and a lab 336, send medical information through HL7 interface 330. HL7 interface 330 provides the messages to locations such as a clinical repository 338, analytics 340, and utilization management 342.

Clinical repository 338 may be a centralized database or information system used to store, manage, and access electronic medical records and other clinical data. Clinical repository 338 may be used by healthcare organizations to improve the accessibility and accuracy of patient information, support clinical decision making, and facilitate research and population health management.

Analytics 340 may refer to the use of data, statistical algorithms, and machine learning techniques to identify and analyze patterns, relationships, and trends in healthcare data with the goal of improving clinical and business outcomes. Analytics 340 may be used to analyze patient outcomes, cost savings, resource utilization, population health management, fraud detection, and more. Healthcare analytics is used in various areas such as patient care, hospital management, pharmaceuticals, public health, and medical research.

Utilization management 342 may be used to optimize the use of healthcare resources and ensure that patients receive appropriate, high-quality care. Utilization management 342 may involve evaluating and coordinating the use of medical services, supplies, and medications to ensure that they meet established standards of care, are medically necessary, and are cost-effective. Utilization management activities may include pre-authorization of services, concurrent review of patient care, discharge planning, and case management.

HL7 interface 330 is a type of interface used in healthcare information systems to exchange patient health information between different healthcare applications, systems, and organizations. HL7 interface 330 may enable the transfer of patient data such as demographic information, clinical observations, and diagnostic results, among others, between systems in a standardized format. HL7 interface 330 may ensure that the data is accurate, consistent, and available to all authorized healthcare providers, leading to improved patient care and reduced errors and duplications. HL7 interface 330 may use standard HL7 protocols and message structures to ensure seamless and secure exchange of patient data between different healthcare entities.

HL7 interface 330 may allow for data flow orchestration, message routing, data validation, data normalization (format conversion and mapping) and custom scripting supported internally or via external call outs. The functionality of the medical coding string correction may occur at or before HL7 interface 330.

In the example of FIG. 3, hospital 332 sends a Clinical Document Architecture (CDA) document to HL7 interface 330. CDA is a standard for the representation of electronic clinical documents, such as discharge summaries and progress notes. CDA is based on XML and is designed to be used within the HL7 framework. Clinic 334 send a Fast Healthcare Interoperability Resources (FHIR) message. FHIR is a newer standard for exchanging healthcare information, designed to be more modern, flexible, and scalable. FHIR uses RESTful APIs and JSON or XML data formats. Lab 336 uses V2 messaging messages to HL7 interface 330. HL7 version 2 (v2) is a HL7 standard which is a mature and well-established standard for exchanging healthcare information.

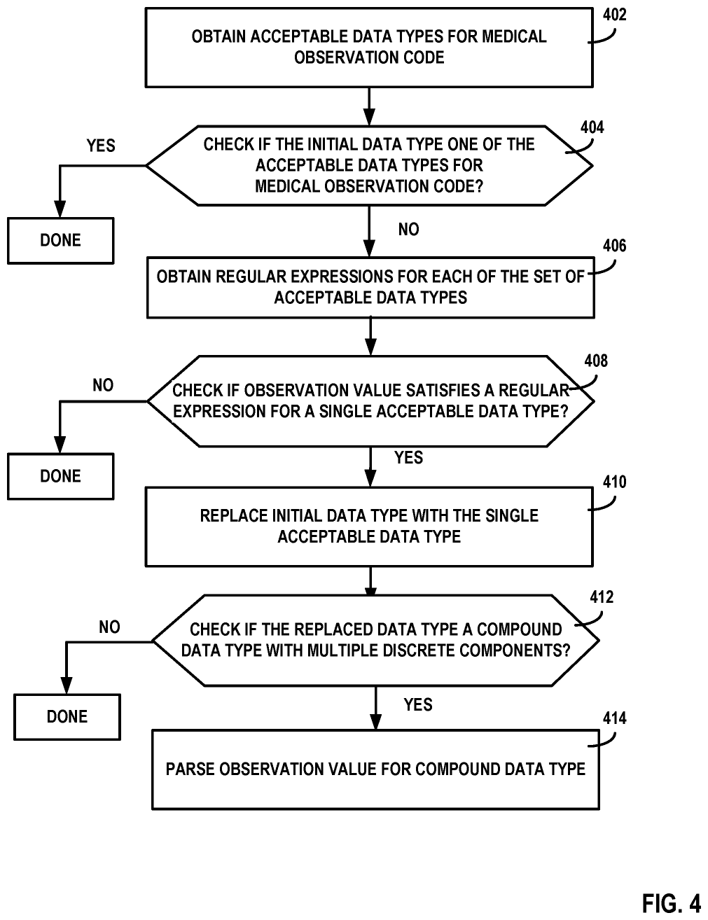

FIG. 4 is a flow chart that illustrates an example process for medical information string correction in accordance with one or more aspects of this disclosure. FIG. 4 is described below in the context of computing system 202 of FIG. 2. In this example, when an observation arrives in any HL7 format, computing system 202 may verify that the observation type is indicated by a medical observation code such as a Logical Observation Identifiers Names and Codes (LOINC) term. Many observations are tagged with LOINC codes. For example, the LOINC code for a Hemoglobin A1c blood test is 4548-4.

In this example, computing system 202 may extract the medical procedure code, such as a LOINC code, used to identify the observation type. In HL7 V2 Messages, LOINC codes are found in the OBX-3 (Observation Identifier) field where the CWE.3 (Name of Coding System) or CWE.6 (Name of Alternate Coding System) component is set to “LN”. In HL7 CDA, LOINC codes are found in the XML <code> elements of specified templates with the codeSystem attribute set to “2.16.840.1.113883.6.1”. In HL7 FHIR, LOINC codes are found in Observation.code elements with the CodeableConcept.coding.system element set to “http://loinc.org”. If a LOINC code is found then proceed to the next step.

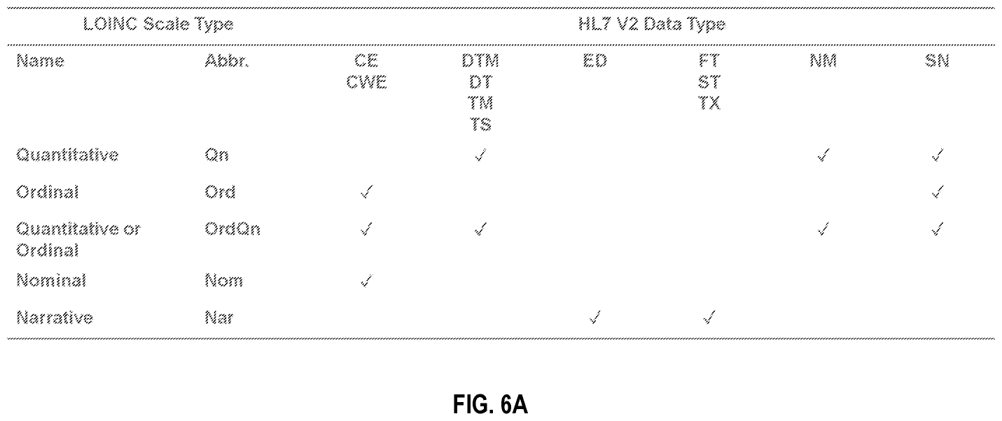

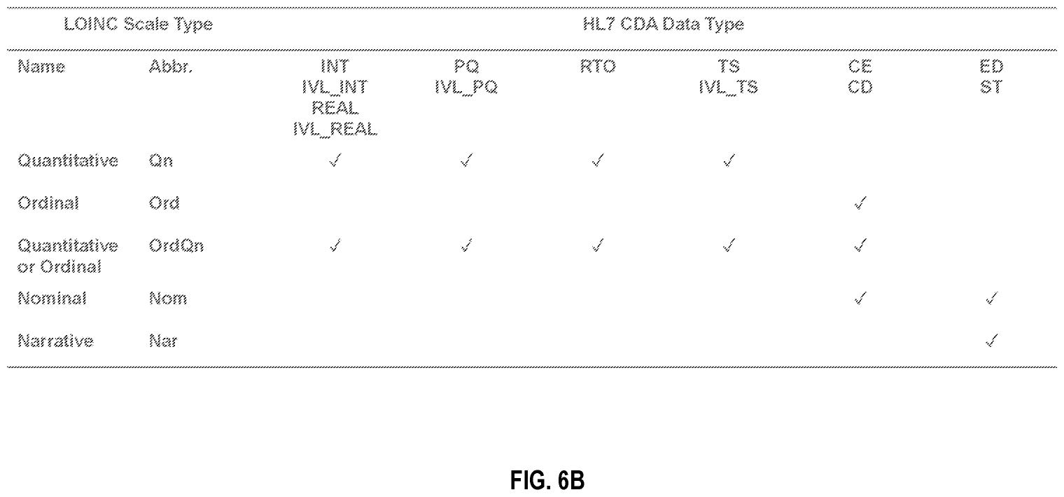

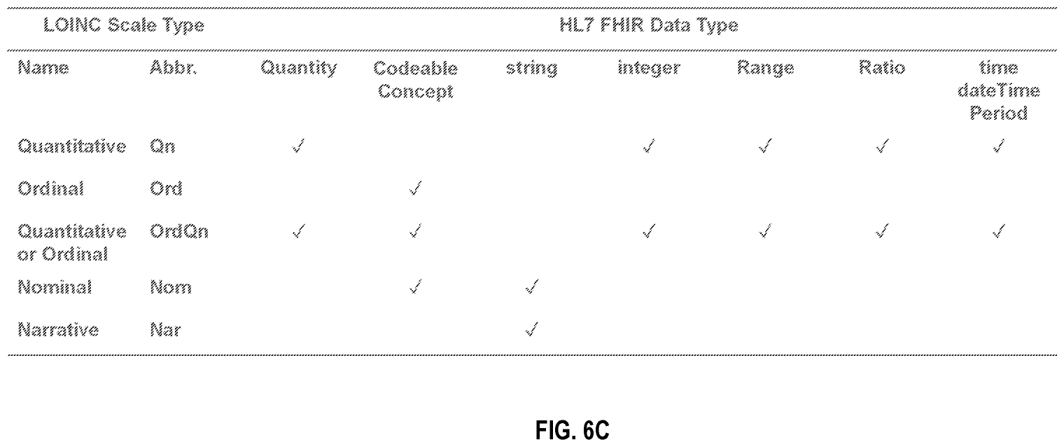

Computing system 202 may obtain the acceptable data types for the medical observation code, such as the LOINC code (402). For example, computing system 202 may look up a scale type in the LOINC database. The LOINC database may be accessed online, such as from the Regenstrief Institute, or the LOINC database may be stored locally. Computing system 202 may use a mapping table to identify the set of HL7 data types allowed for the applicable HL7 standard and LOINC scale. Those mapping tables are published in HL7 standards. Examples of such mapping tables are shown in FIGS. 6A-C discussed below. For example, LOINC code 4548-4 has a scale of Quantitative (Qn) and so for HL7 V2 Messaging the allowed data types are: NM (Numeric), SN (Structured Numeric), TS (Timestamp), DTM (Date/time), TM (Time), DT (Date).

Computing system 202 may check if the initial data type is one of the acceptable data types for the medical observation code (404). In the example of FIG. 4, if the initial data type is one of the acceptable data types (“YES” branch of 404), the process of FIG. 4 is done because the initial data type is valid and there is no need for correction.

If the initial data type is not one of the set of acceptable data types (“NO” branch of 404), computing system 202 may obtain the regular expressions for each of the set of acceptable data types (406). Computing system 202 may check if the observation value satisfies a regular expression for a single acceptable data type (408). Step 408 may be done in other ways other than using regex as discussed above. For example, computing system 202 may iterate through the set of allowed HL7 data types identified in the previous step. For each data type, apply a stored regular expression (regex) to the observation value. If the observation value does not satisfy a regular expression for a single acceptable data type (for example, the observation value satisfies zero or more than one of the regular expressions but not exactly one regular expression) (“NO” branch of 408), the process of FIG. 4 may be done because computing system 202 may not be able to correct of the initial data type. If the observation value does satisfy a regular expression for a single acceptable data type (“YES” branch of 408), computing system 202 may replace the initial data type with the single acceptable data type (410).

Additionally, computing system 202 may check if the replaced data type is a compound data type with multiple discrete components (412). If the replaced data type is a compound data type with multiple discrete components (“YES” branch of 412), such as the structured numeric data type, then computing system 202 may parse the observation value (414). For example, computing system 202 may determine the multiple discrete component values of the compound data type for the observation value For example, if the data is in HL7 V2 Messaging format and the matched data type is SN (Structured Numeric) and the observation value is “3.0-4.0” then parse the value into the four SN components: SN.1 (Comparator)=“ ” (not populated), SN.2 (Num1)=“3.0”, SN.3 (Separator/Suffix)=“-”, SN.4 (Num2)=“4.0”. The process of FIG. 4 may be done if the replaced data type is not a compound data type (“NO” branch of 412).

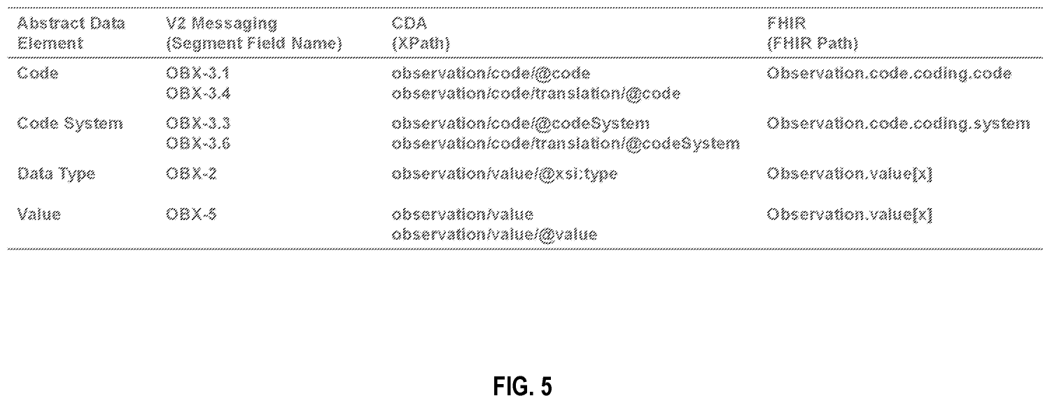

FIG. 5 is a diagram that illustrates HL7 Observation Data Elements in accordance with one or more aspects of this disclosure. The location of the Code (medical observation code), Code System, Data Type and Value (observation value) are shown for V2 messaging, CDA and FHIR. For V2 messaging, OBX (Observation/Result segment) is a message structure used to represent a single observation or test result within a patient's electronic health record. For example, the data type is in OBX-2. CDA is XML (Extensible Markup Language) based and may use XPath (XML Path Language) to navigate and select data from a CDA element. For example, the data type may be obtained from “observation/value/@xsi:type”. FHIR Path (Fast Healthcare Interoperability Resources Path) is a language used to query and manipulate data represented using the FHIR (Fast Healthcare Interoperability Resources) standard. FHIR Path is used to extract information from FHIR resources and perform operations on that data. For example, the data type may be obtained using “Observation.value[x]”.

FIGS. 6A-C are diagrams that illustrate LOINC Scale Types relations to data types in accordance with one or more aspects of this disclosure. A given LOINC Scale Type may correspond to multiple data types for V2 messaging, CDA, or FHIR. In one example, computing system 202 uses the LONIC medical observation code to determine the LONIC Scale Type which computing system 202 may use to obtain the set of acceptable data types for V2 messaging, CDA, or FHIR. As discussed below with respect to FIGS. 7A-C, computing system 202 may obtain a regex for each of the set of acceptable data types to evaluate the observation value. FIG. 6A illustrates the relation of LOINC Scale Type to the V2 data type. For example, the LOINC scale type Qn (Quantitative) corresponds to the V2 messaging data types DTM (Date/Time/Period), DT (Date), TM (Time), TS (Timestamp), NM (Numeric) and SN (structured numeric). FIG. 6B illustrates the relation of LOINC Scale Type to the CDA data type. For example, the LOINC scale type Quantitative corresponds to CDA data types of PQ (Physical Quantity) IVL_PQ (Interval of Physical Quantity) RTO (Ratio of Physical Quantities) TS (Timestamp) IVL_TS (Interval of Timestamp), and CE (Coded Entry). FIG. 6C illustrates the relation of LOINC Scale Type to the FHIR data type. For example, the LOINC scale type Quantitative corresponds to FHIR data types of quantity, integer, range, ratio, time date and time period.

FIGS. 7A-C are diagrams that illustrate example regular expressions for data types in accordance with one or more aspects of this disclosure. These regular expressions are only examples, and implementers could write other regular expressions which would achieve the same functionality.

Computing system 202 may obtain a regex for each of the set of acceptable data types to evaluate the observation value as discussed with respect to FIG. 4 above. FIG. 7A illustrates regular expressions for HL7 V2 messaging data types. FIG. 7B illustrates regular expressions for HL7 CDA data types. FIG. 7C illustrates regular expressions for FHIR data types. For example, the regular expression for NM in V2 messaging is “[+\−]?\d{1, 16}(\. \d{1,16})?” which means that there is an optional + or − followed by 1 to 16 digits followed by an optional subexpression group of “.” followed by 1 to 16 digits. Thus, “12” and “−1.1” would be satisfied but “five” would not.

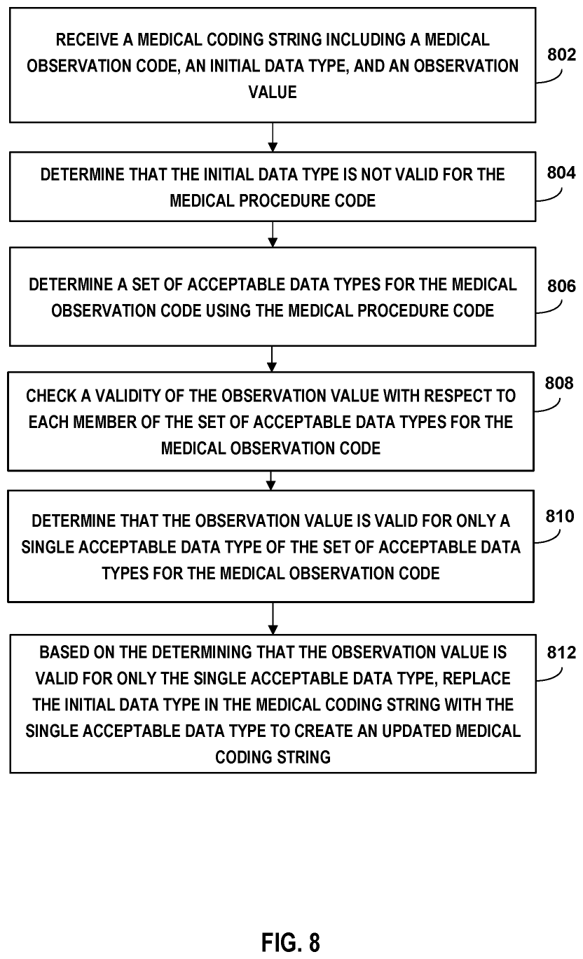

FIG. 8 is a flowchart that illustrates a method in accordance with one or more aspects of this disclosure. FIG. 8 is described below in the context of computing system 202 of FIG. 2. As shown in FIG. 8, computing system 202 may receive a medical coding string including a medical observation code, an initial data type, and an observation value (802). For example, given a HL7 V2 input fragment (medical coding string) assuming HL7 recommended separator (delimiter) characters: OBX∥ST|5315-7\hat{ }Rickettsia spotted fever group Ab.IgM\hat{ }LN∥<1:64∥∥∥F, the medical observation code (LOINC code) is 5315-7, the initial data type is “ST” (string); and the observation value is “<1:64”.

Computing system 202 may determine whether the initial data type is valid for the medical observation code (804). In some examples, computing system 202 may determine whether the initial data type is valid for the medical observation code by determining the acceptable data types for the medical observation code and determining whether the initial data type is one of the acceptable data types. In the example above, LOINC code 5315-7 (Rickettsia spotted fever group IgM Ab [Titer] in Serum by Immunofluorescence) has scale type Qn (quantitative). As shown in FIG. 6A, the LOINC scale type Qn (Quantitative) corresponds to the V2 messaging data types DTM (Date/Time/Period), DT (Date), TM (Time), TS (Timestamp), NM (Numeric) and SN (structured numeric). Since the acceptable HL7 data types for V2 messaging with LOINC code 5315-7 are NM, SN, TM, DTM (DT, TS), but not ST, computing system 202 may determine that that the initial data type, “ST”, is not valid for the medical observation code, LOINC code 5315-7. If the initial data type was valid, then computing system 202 need not modify the medical coding string and the method is done.

Computing system 202 may determine a set of acceptable data types for the medical observation code using the medical observation code (806). In some examples, computing system 202 may determine the acceptable data types for the medical observation code by looking up the acceptable data types from a database. In the example above, LOINC code 5315-7 has scale type Qn which corresponds to the V2 messaging data types DTM (Date/Time/Period), DT (Date), TM (Time), TS (Timestamp), NM (Numeric) and SN (structured numeric).

Computing system 202 may check a validity of the observation value with respect to each member of the set of acceptable data types for the medical observation code (808). In some examples, computing system 202 obtains the regex for each of the set of acceptable data types and then uses those regexes to see which observation values satisfy these regexes. In the example above, LOINC code 5315-7 has scale type Qn which corresponds to the V2 messaging data types DTM (Date/Time/Period), DT (Date), TM (Time), TS (Timestamp), NM (Numeric) and SN (structured numeric). Examples of such regular expressions for these data types are shown in FIG. 7A. In the example, observation “<1:64”, does not satisfy NM (Numeric), does not satisfy TM (Time), and does not satisfy DTM (Date/Time) but does satisfy SN (Structured Numeric).

Computing system 202 may determine that the observation value is valid for only a single acceptable data type of the set of acceptable data types for the medical observation code (810). In the example, observation “<1:64” only satisfies SN (Structured Numeric) out of the set of acceptable data types.

Computing system 202 may, based on the determining that the observation value is valid for only the single acceptable data type, replace the initial data type in the medical coding string with the single acceptable data type to create an updated medical coding string (812). In the example above, computing system 202 may change the initial data type of ST to the corrected data type SN. If no or multiple data types are satisfied, computing system 202 may not be able to correct the initial data type.

In the example, SN is a compound data group and, in the example, the observation value may be parsed as SN.1=“<”, SN.2=“1”, SN.3=“:”, SN.4=“64” to produce a HL7 V2 output fragment: OBX∥SN|5315-7\hat{ }Rickettsia spotted fever group Ab.IgM\hat{ }LN∥<\hat{ }1\hat{ }:\hat{ }64∥∥∥F.

The following is a non-limiting list of examples that are in accordance with one or more techniques of this disclosure.

Example 1: A method comprising: receiving, by a computing system, a medical coding string including a medical observation code, an initial data type, and an observation value; determining, by the computing system, that the initial data type is not valid for the medical observation code; determining, by the computing system, a set of acceptable data types for the medical observation code using the medical observation code; checking, by the computing system, a validity of the observation value with respect to each member of the set of acceptable data types for the medical observation code; determining, by the computing system, that the observation value is valid for only a single acceptable data type of the set of acceptable data types for the medical observation code; and based on the determining that the observation value is valid for only the single acceptable data type, replacing, by the computing system, the initial data type in the medical coding string with the single acceptable data type to create an updated medical coding string.

Example 2: The method of example 1, wherein the single acceptable data type is a compound data type, further comprising parsing, by the computing system, the observation value to follow the compound data type.

Example 3: The method of examples 1-2, wherein determining that the initial data type is not valid for the medical observation code includes determining, by the computing system, that the initial data type is not one of the set of acceptable data types for the medical observation code.

Example 4: The method of examples 1-3, wherein checking the validity of the observation value with respect to each member of the set of acceptable data types for the medical observation code includes: obtaining, by the computing system, a regular expression (regex) for each member of the set of acceptable data types; and for each member of the set of acceptable data types, checking, by the computing system, the observation value to determine if the observation value satisfies the regular expression for that member.

Example 5: The method of example 4, wherein determining that the observation value is valid for only the single acceptable data type includes determining, by the computing system, that the regular expression for the single acceptable data type satisfies the observation value.

Example 6: The method of examples 1-5, wherein the set of acceptable data types only has a single data type and wherein determining that the observation value is valid for a single acceptable data type includes determining, by the computing system, that the observation value satisfies the single data type.

Example 7: The method of examples 1-6, wherein the set of acceptable data types has multiple data types and wherein determining that the observation value is valid for a single acceptable data type includes determining, by the computing system, that the observation value satisfies the single acceptable data type but does not satisfy any other data type of the set of acceptable data types.

Example 8: The method of examples 1-7, wherein the medical coding string uses an HL7 (Health Level 7) format.

Example 9: The method of examples 1-8, wherein the medical observation code is a LOINC (Logical Observation Identifiers Names and Codes) code with associated scale type associated with the set of acceptable data types.

Example 10: A computing system comprising: a communication unit configured to connect with a network; and one or more processors implemented in circuitry and in communication with the communication unit, the one or more processors configured to: receive a medical coding string including a medical observation code, an initial data type, and an observation value; determine that the initial data type is not valid for the medical observation code; determine a set of acceptable data types for the medical observation code using the medical observation code; check a validity of the observation value with respect to each member of the set of acceptable data types for the medical observation code; determine that the observation value is valid for only a single acceptable data type of the set of acceptable data types for the medical observation code; and based on the determination that the observation value is valid for only the single acceptable data type, replace the initial data type in the medical coding string with the single acceptable data type to create an updated medical coding string.

Example 11: The computing system of example 10, wherein the single acceptable data type is a compound data type, wherein the one or more processors are further configured to parse the observation value to follow the compound data type.

Example 12: The computing system of examples 10-11, wherein the one or more processors are further configured to determine that the initial data type is not one of the set of acceptable data types for the medical observation code as part of determining that the initial data type is not valid for the medical observation code.

Example 13: The computing system of examples 10-12, wherein the one or more processors are further, as part of checking the validity of the observation value with respect to each member of the set of acceptable data types for the medical observation code, configured to: obtain a regular expression (regex) for each member of the set of acceptable data types; and for each member of the set of acceptable data types, check the observation value to determine if he observation value satisfies the regular expression for that member.

Example 14: The computing system of example 13, wherein the one or more processors are further, as part of determining that the observation value is valid for only the single acceptable data type, configured to determine that the regular expression for the single acceptable data type satisfies the observation value.

Example 15: The computing system of examples 10-14, wherein the set of acceptable data types only has a single data type and wherein the one or more processors are further, as part of determining that the observation value is valid for a single acceptable data type, configured to determine that the observation value satisfies the single data type.

Example 16: The computing system of examples 10-15, wherein the set of acceptable data types has multiple data types and wherein the one or more processors are further, as part of determining that the observation value is valid for a single acceptable data type, configured to determine that the observation value satisfies the single acceptable data type but does not satisfy any other data type of the set of acceptable data types.

Example 17: The computing system of examples 10-16, wherein the medical coding string uses an HL7 (Health Level 7) format.

Example 18: The computing system of examples 10-17, wherein the medical observation code is a LOINC (Logical Observation Identifiers Names and Codes) code with associated scale type associated with the set of acceptable data types.

Example 19: A non-transitory computer-readable medium having instructions stored thereon that, when executed, cause one or more processors to: receive a medical coding string including a medical observation code, an initial data type, and an observation value; determine that the initial data type is not valid for the medical observation code; determine a set of acceptable data types for the medical observation code using the medical observation code; check a validity of the observation value with respect to each member of the set of acceptable data types for the medical observation code; determine that the observation value is valid for only a single acceptable data type of the set of acceptable data types for the medical observation code; and based on the determining that the observation value is valid for only the single acceptable data type, replace the initial data type in the medical coding string with the single acceptable data type to create an updated medical coding string.

Example 20: The non-transitory computer-readable medium of example 19, wherein the single acceptable data type is a compound data type, further comprising instructions that, when executed, cause one or more processors to parse the observation value to follow the compound data type

Example 21: The non-transitory computer-readable medium of examples 19-20, wherein determining that the initial data type is not valid for the medical observation code includes determining, by the computing system, that the initial data type is not one of the set of acceptable data types for the medical observation code.

Example 22: The non-transitory computer-readable medium of examples 19-21, wherein checking the validity of the observation value with respect to each member of the set of acceptable data types for the medical observation code includes: obtaining, by the computing system, a regular expression (regex) for each member of the set of acceptable data types; and for each member of the set of acceptable data types, checking, by the computing system, the observation value to determine if the observation value satisfies the regular expression for that member.

Example 23: The non-transitory computer-readable medium of example 22, wherein determining that the observation value is valid for only the single acceptable data type includes determining, by the computing system, that the regular expression for the single acceptable data type satisfies the observation value.

Example 24: The non-transitory computer-readable medium of examples 19-23, wherein the set of acceptable data types only has a single data type and wherein determining that the observation value is valid for a single acceptable data type includes determining, by the computing system, that the observation value satisfies the single data type.

Example 25: The non-transitory computer-readable medium of examples 19-24, wherein the set of acceptable data types has multiple data types and wherein determining that the observation value is valid for a single acceptable data type includes determining, by the computing system, that the observation value satisfies the single acceptable data type but does not satisfy any other data type of the set of acceptable data types.

Example 26: The non-transitory computer-readable medium of examples 19-25, wherein the medical coding string uses an HL7 (Health Level 7) format.

Example 27: The non-transitory computer-readable medium of examples 19-26, wherein the medical observation code is a LOINC (Logical Observation Identifiers Names and Codes) code with associated scale type associated with the set of acceptable data types.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers, processing circuitry, or one or more processors to retrieve instructions, code and/or data structures for implementation of the techniques described in this disclosure. A computer program product may include a computer-readable medium.

By way of example, and not limitation, such computer-readable storage media may include RAM, ROM, EEPROM, CD-ROM, or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by processing circuitry (e.g., one or more processors, such as one or more DSPs, general purpose microprocessors, ASICs, FPGAs, or other equivalent integrated or discrete logic circuitry), as well as any combination of such components. Accordingly, the term “processor” or “processing circuitry” as used herein, may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A method comprising:
receiving, by a computing system, a medical coding string including a medical observation code, an initial data type, and an observation value;
determining, by the computing system, that the initial data type is not valid for the medical observation code;
determining, by the computing system, a set of acceptable data types for the medical observation code using the medical observation code;
checking, by the computing system, a validity of the observation value with respect to each member of the set of acceptable data types for the medical observation code;
determining, by the computing system, that the observation value is valid for only a single acceptable data type of the set of acceptable data types for the medical observation code; and
based on the determining that the observation value is valid for only the single acceptable data type, replacing, by the computing system, the initial data type in the medical coding string with the single acceptable data type to create an updated medical coding string.

2. The method of claim 1, wherein the single acceptable data type is a compound data type, further comprising parsing, by the computing system, the observation value to follow the compound data type.

3. The method of claim 1, wherein determining that the initial data type is not valid for the medical observation code includes determining, by the computing system, that the initial data type is not one of the set of acceptable data types for the medical observation code.

4. The method of claim 1, wherein checking the validity of the observation value with respect to each member of the set of acceptable data types for the medical observation code includes:
obtaining, by the computing system, a regular expression (regex) for each member of the set of acceptable data types; and
for each member of the set of acceptable data types, checking, by the computing system, the observation value to determine if the observation value satisfies the regular expression for that member.

5. The method of claim 4, wherein determining that the observation value is valid for only the single acceptable data type includes determining, by the computing system, that the regular expression for the single acceptable data type satisfies the observation value.

6. The method of claim 1, wherein the set of acceptable data types only has a single data type and wherein determining that the observation value is valid for a single acceptable data type includes determining, by the computing system, that the observation value satisfies the single data type.

7. The method of claim 1, wherein the set of acceptable data types has multiple data types and wherein determining that the observation value is valid for a single acceptable data type includes determining, by the computing system, that the observation value satisfies the single acceptable data type but does not satisfy any other data type of the set of acceptable data types.

8. The method of claim 1, wherein the medical coding string uses an HL7 (Health Level 7) format.

9. The method of claim 1, wherein the medical observation code is a LOINC (Logical Observation Identifiers Names and Codes) code with associated scale type associated with the set of acceptable data types.

10. A computing system comprising:
a communication unit configured to connect with a network; and
one or more processors implemented in circuitry and in communication with the communication unit, the one or more processors configured to:
receive a medical coding string including a medical observation code, an initial data type, and an observation value;
determine that the initial data type is not valid for the medical observation code;
determine a set of acceptable data types for the medical observation code using the medical observation code;
check a validity of the observation value with respect to each member of the set of acceptable data types for the medical observation code;
determine that the observation value is valid for only a single acceptable data type of the set of acceptable data types for the medical observation code; and
based on the determining that the observation value is valid for only the single acceptable data type, replace the initial data type in the medical coding string with the single acceptable data type to create an updated medical coding string.

11. The computing system of claim 10, wherein the single acceptable data type is a compound data type, wherein the one or more processors are further configured to parse the observation value to follow the compound data type.

12. The computing system of claim 10, wherein the one or more processors are further configured to determine that the initial data type is not one of the set of acceptable data types for the medical observation code as part of determining that the initial data type is not valid for the medical observation code.

13. The computing system of claim 10, wherein the one or more processors are further, as part of checking the validity of the observation value with respect to each member of the set of acceptable data types for the medical observation code, configured to:
obtain a regular expression (regex) for each member of the set of acceptable data types; and
for each member of the set of acceptable data types, check the observation value to determine if he observation value satisfies the regular expression for that member.

14. The computing system of claim 13, wherein the one or more processors are further, as part of determining that the observation value is valid for only the single acceptable data type, configured to determine that the regular expression for the single acceptable data type satisfies the observation value.

15. The computing system of claim 10, wherein the set of acceptable data types only has a single data type and wherein the one or more processors are further, as part of determining that the observation value is valid for a single acceptable data type, configured to determine that the observation value satisfies the single data type.

16. The computing system of claim 10, wherein the set of acceptable data types has multiple data types and wherein the one or more processors are further, as part of determining that the observation value is valid for a single acceptable data type, configured to determine that the observation value satisfies the single acceptable data type but does not satisfy any other data type of the set of acceptable data types.

17. The computing system of claim 10, wherein the medical coding string uses an HL7 (Health Level 7) format.

18. The computing system of claim 10, wherein the medical observation code is a LOINC (Logical Observation Identifiers Names and Codes) code with associated scale type associated with the set of acceptable data types.

19. A non-transitory computer-readable medium having instructions stored thereon that, when executed, cause one or more processors to:
receive a medical coding string including a medical observation code, an initial data type, and an observation value;
determine that the initial data type is not valid for the medical observation code;
determine a set of acceptable data types for the medical observation code using the medical observation code;
check a validity of the observation value with respect to each member of the set of acceptable data types for the medical observation code;
determine that the observation value is valid for only a single acceptable data type of the set of acceptable data types for the medical observation code; and
based on the determining that the observation value is valid for only the single acceptable data type, replace the initial data type in the medical coding string with the single acceptable data type to create an updated medical coding string.

20. The non-transitory computer-readable medium of claim 19, wherein the single acceptable data type is a compound data type, further comprising instructions that, when executed, cause one or more processors to parse the observation value to follow the compound data type.
